(19) United States
(12) Patent Application Publication
(10) Pub. No.: US 2026/0289678 A1
(43) Pub. Date: Sep. 24, 2026

(54) SYSTEMS AND METHODS FOR INVENTORY MANAGEMENT AND OPTIMIZATION

(71) Applicant: JPMORGAN CHASE BANK, N.A., New York, NY (US)

(72) Inventors: Rohit JAIN, Glen Rock, NJ (US); Jimmie IRBY, Westerville, OH (US); Karl LOHNINGER, Towaco, NJ (US); David N MARTUCCI, Greenwich, CT (US)

(21) Appl. No.: 19/569,771

(22) Filed: Mar. 17, 2026

Related U.S. Application Data
(60) Provisional application No. 63/775,559, filed on Mar. 21, 2025.

(51) Int. Cl. G06Q 40/06

(52) U.S. Cl. CPC G06Q 40/0631

(57) ABSTRACT

In some embodiments, the techniques described herein relate to a method including determining, by an instrument engine executed by a server comprising one or more processors, potential accessible tradeable assets and unknown accessible tradeable assets associated with a financial account. The method may include determining, by a dashboard engine executed by the server, a state of a financial account and related guidelines. The method may include determining, by a risk engine executed by the server, one or more risk limits and one or more internal guidelines of a trade associated with the potential accessible tradeable assets or unknown accessible tradeable assets. The method may include determining displaying, by an exposure engine executed by the server, one or more holdings or analyst views. The method may include determining, by a large language model executed by the server, a portfolio insight.

### RELATED APPLICATIONS

This application claims priority to, and the benefit of, U.S. Provisional Patent Application Ser. No. 63/775,559, filed Mar. 21, 2025, the disclosure of which is hereby incorporated, by reference in its entirety.

### BACKGROUND

### 1. Field of The Invention

Embodiments generally relate to systems and methods for inventory management and optimization for digital accounts.

### 2. Description of the Related Art

A variety of financial products are accessible to users through network-accessible platforms that present account information, market information, trade information, research, messaging, and analyst commentary. Such platforms may be used by individual investors, asset managers, treasurers, and other institutional users to monitor holdings, evaluate opportunities, and execute transactions across multiple asset classes, including corporate instruments, money market instruments, and treasury instruments. As the number of products, venues, issuers, and data sources continues to increase, the volume, velocity, and heterogeneity of information available to a user likewise increases.

Conventional portfolio and trading systems often present large quantities of raw or lightly processed data to a user, such as lists of offerings, quotes, spreads, yields, durations, news items, and communications. However, presenting excessive information without sufficient normalization, prioritization, or contextualization can degrade decision making, increase cognitive load, and make it difficult for the user to identify which data is most relevant to a current objective, guideline, or constraint. For example, users may be required to manually reconcile inconsistent naming conventions, incomplete fields, duplicate listings, or differing identifiers for the same instrument across multiple sources. In fixed income markets in particular, differences in issuer naming, coupon conventions, maturity formats, and descriptive strings can produce fragmented records that are not easily aggregated into a single view of inventory and exposure.

Additionally, portfolio decision making is frequently constrained by guidelines and risk frameworks that may include institution-level constraints as well as account-specific constraints. Examples can include concentration limits, issuer approval lists, minimum ratings, duration bands, liquidity requirements, sector caps, and other constraints. In many systems, such guidelines are stored in formats that are not readily machine actionable, are applied in an ad hoc manner, or require manual review by compliance or risk personnel. As a result, pre-trade evaluation and “room to grow” calculations may be slow, inconsistent, or dependent on the experience of a particular trader or analyst, thereby increasing operational risk and the likelihood that a proposed trade is later determined to be non-compliant.

Further, many users desire decision support that goes beyond static reporting and instead provides actionable insights, such as identifying relative value opportunities, ranking candidate instruments, suggesting trades consistent with constraints, and adapting suggestions based on changing market conditions and executed trades. While advances in machine learning and artificial intelligence have been applied to financial analytics and user interfaces, conventional implementations can suffer from several drawbacks. Some systems generate recommendations without sufficiently explaining the underlying basis, without appropriately incorporating account guidelines and real-time exposure, or without a robust feedback loop that improves subsequent suggestions based on execution outcomes.

Moreover, the increasing use of large language models and other generative approaches in financial applications introduces additional technical and practical concerns. Generative models can produce fluent responses that may be inaccurate, incomplete, or unsupported by available data, sometimes referred to as hallucinations. In a regulated environment, presenting unsupported statements regarding holdings, compliance, pricing, or expected performance can lead to user confusion, unsuitable recommendations, or improper reliance on machine-generated outputs. Conventional systems may lack safeguards that constrain model outputs to verified inventory reference data, apply confidence scoring, or ensure that generated insights remain consistent with account-specific and internal risk guidelines.

Accordingly, there is a need for improved systems and methods that can integrate heterogeneous inventory sources, normalize and de-duplicate instrument records, determine and present relevant inventory categories and reference data, compute exposure and guideline compliance in a machine-readable manner, and generate prioritized, optimized, and explainable portfolio insights and suggested actions. There is also a need for systems that incorporate automated pre-trade compliance checks, enable efficient order routing or execution, and incorporate post-trade analytics feedback to refine subsequent optimization and insights, while mitigating risks associated with unreliable or hallucinated machine learning outputs.

### SUMMARY

Exemplary embodiments provide systems and methods for identity proofing. According to one embodiment, a method may include receiving, by determining, by an instrument engine executed by a server comprising one or more processors, potential inventories and unknown inventories associated with a financial account; determining, by a dashboard engine executed by the server, a state of a financial account and related guidelines; determining, by a risk engine executed by the server, one or more risk limits and one or more internal guidelines of a trade associated with the potential inventories and unknown inventories; displaying, by an exposure engine executed by the server, one or more holdings or analyst views; displaying, by a portfolio dashboard executed by the server, an account view, a cash-to-spend view, and an account exposure limit and a current limit; determining, by a large language model comprising a machine learning model executed by the server, a portfolio insight, a variation versus a model and a suggested action; optimizing, by a portfolio optimizer executed by the server, the financial account based on a duration, a risk, a sector, and an adjusted liquidity; determining, by an order management system executed by the server, pre-trade compliance and enriching data with liquidity provider data, the order management system configured to send an order to the user for execution, the order comprising a direct order routing and a portfolio trade execution; and determining, by a trade analyzer by the server, the trade analytics being used by the portfolio optimizer to incorporate feedback of the trade into the optimizer for the suggested action.

Systems and methods disclosed herein may include adding an evidence-constrained portfolio-insight workflow in which authoritative data items are retrieved and used to generate a candidate insight, a support score is computed to measure consistency with the authoritative data, unsupported content is suppressed or rewritten, per-sentence or per-clause evidence pointers are required for displayed output, and/or an auditable record (including hashed inputs and identifiers) is stored.

Systems and methods disclosed herein may include adding guideline digitization and compliance tooling in which guideline source content is compiled into a machine-readable rule graph, a runtime compliance engine evaluates proposed trades against the rule graph to produce pre-trade compliance, an explanation path identifies which constraint nodes drove the decision, and/or a counterfactual simulator produces closest compliant trade alternatives and identifies binding constraints.

Systems and methods disclosed herein may include adding instrument identity normalization by generating stable instrument identifiers using deterministic canonicalization and hashing, maintaining mappings between source-specific identifiers and stable identifiers, and/or generating secondary identifiers with wildcard tokens and confidence scores when input fields are missing.

Systems and methods disclosed herein may include adding an event-driven streaming update architecture that ingests market and account events, deduplicates events using an event identifier, maintains an account state snapshot, and/or restricts optimizer recomputation to impacted instruments and constraints using a dependency index.

Systems and methods disclosed herein may include adding closed-loop execution learning, explainability, and sandboxing by computing post-trade execution feedback features, storing them in an indexed feature store, using them in subsequent optimization iterations, generating a deterministic explanation object stored with order records, and/or providing a sandbox execution mode that simulates execution quality and restricts automatic execution unless compliance and quality thresholds are satisfied.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different Embodiments and embodiments.

FIG. 1 is a block diagram of a system for inventory management and optimization for digital accounts, in accordance with embodiments.

FIG. 2 is a method for providing inventory management and optimization for digital accounts, in accordance with embodiments.

FIG. 3 is a block diagram of a computing device for implementing certain Embodiments of the present disclosure.

### DETAILED DESCRIPTION

Embodiments generally relate to systems and methods for inventory management and optimization for digital accounts.

In accordance with embodiments, systems and methods may include receiving, by server, a universe of tradeable assets; adding, by the server, an inventory management application; adding, by the server, indices of potential inventories; querying, by the server, one or more third party services for unknown inventories; determining, by the server, one or more unique inventory identifiers based on the potential inventories and unknown inventories; creating, by the server, a hypothetical account; retrieving, by the server, inventory reference data for held inventories, potential inventories, and unknown inventories; and providing, by the server, a display showing each category of inventories and reference data for each inventory.

In accordance with embodiments, systems and methods may include an instrument engine, executed by a server, configured to determine potential inventories and unknown inventories. Systems and methods may include a dashboard engine, executed by the server, configured to determine a state of a financial account and related guidelines; a risk engine, executed by the server, configured to determine risk limits and one or more internal guidelines. Systems and methods may include an exposure engine, executed by the server, configured to show one or more holdings or analyst views. Systems and methods may include a portfolio dashboard, executed by the server, configured to show account views, cash-to-spend views, and account exposure limits and current limits. Systems and methods may include a large language model comprising a machine learning model configured to provide one or more portfolio insights, a variation versus a model and/or a suggested action. Systems and methods may include a portfolio optimizer comprising a corporation optimizer, a money market optimizer, and a treasury optimizer, the portfolio optimizer comprising a duration, a risk, a sector, and/or an adjusted liquidity. Systems and methods may include the money market optimizer comprising a boom inventory, a real value calculation versus a bills curve. In some embodiments, the treasury optimizer may comprise calculating bills versus notes real valuation, and/or an on/off the run real valuation. Systems and methods may include a market data engine configured to determine inventory pricing and analytics data based on a corporate inventory, a money market inventory, and/or a treasury curve. In some embodiments, the market data engine determining trade analytics may include spreads and trace data. In some embodiments, an order management system may be configured to determine pre-trade compliance and enriching data with liquidity provider data. In some embodiments, the order management system may be configured to automatically execute orders or send orders to the user for execution. In some embodiments, the order may comprise a direct order routing and a portfolio trade execution. In some embodiments, the trade analytics maya be used by the portfolio optimizer to incorporate feedback of the trade into the optimizer for a next action.

The benefits of disclosed systems include providing a user with prioritized and optimized information regarding a number of inventories, a standardization and utility of data from many data sources, and/or real-time account reactions and executions in response to inventory updates, events, and/or improved guidelines. Further, machine learning engines used to provide information to users may be improved.

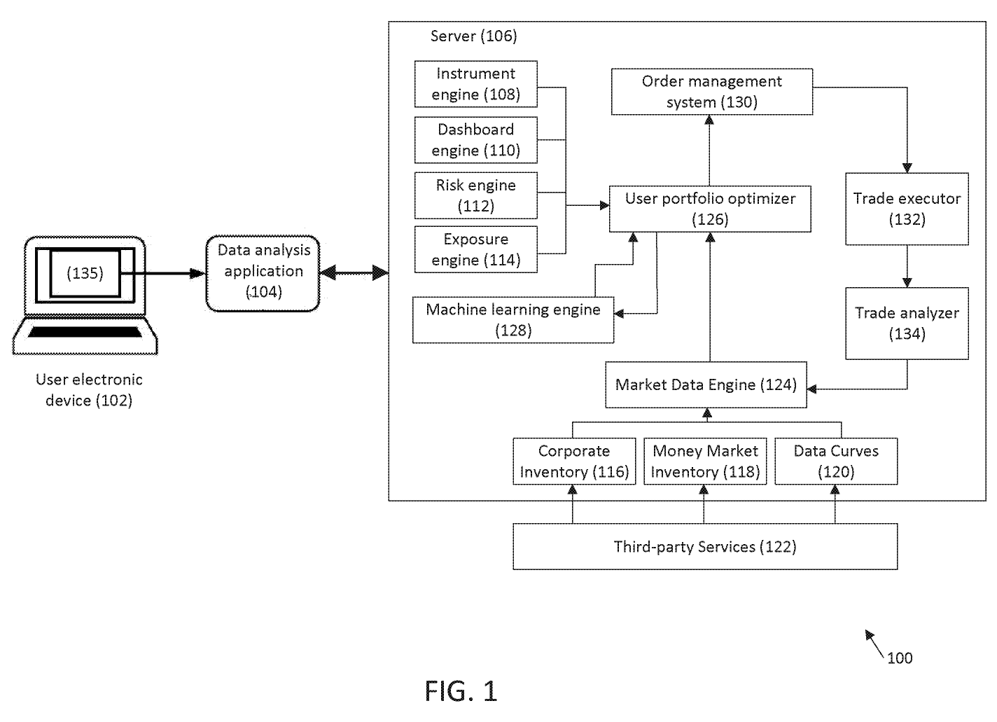

FIG. 1 is a block diagram of a system for identity proofing, in accordance with embodiments. System 100 includes a sender electronic device 102 executing a data analysis application 104 available through a user interface 135, a server 106 executing one or more software modules, and one or more third party services 122. The one or more software modules may include one or more of an instrument engine 108, a dashboard engine 110, a risk engine 112, an exposure engine 114, a corporate inventory 116, a money market inventory 118, a data curve 120, a market data engine 124, a user portfolio optimizer 126, an order management system 130, a trade executor 132, a trade analyzer 134, and a machine learning engine 128. Server 106 may include one or more databases referenced by one or more of the software modules.

In accordance with embodiments, user electronic device 102 may be a user electronic device such as a personal communication device (e.g., tablet, phone), computer workstation, laptop, or other electronic processing device in operative communication with data analysis application 104 and/or server 106. User electronic device 102 may be configured to interact with data analysis application 104 through user interface 135. For instance, user electronic device 102 may include a client application that allows a user of user electronic device 102 to interact with data analysis application 104. User interface 135 may include one or more graphical user interfaces to receive inputs and/or display information to the user. User interface 135 and/or data analysis application 104 may comprise one or more instructions executed by one or more processors of user electronic device 102. Data analysis application 104 may be a production business application provided by a service organization. In an exemplary aspect, data analysis application 104 may be a portfolio management application or system.

In accordance with embodiments, a user of user electronic device 102 may attempt to process a transaction of an asset or money of an electronically managed account or digitized account in a portfolio accessible through data analysis application 104. In some embodiments, the user may be an individual or organization. A “digitized” account’s risk guidelines are machine readable and that enables the account to participate in “room to grow” calculations – how much of an instrument an account can buy and remain compliant with financial institution risk guidelines and/or account specific guidelines. A digitized account enables machine learning models to learn from past trades, current market conditions, available inventory, and/or investment themes to be able to suggest trades.

Interface 135 may be any suitable interface for receiving send and/or recipient information from sender electronic device 102, data analysis application 104, or another application. For instance, interface 135 may be a graphical user interface.

In accordance with embodiments, recipient and/or transaction information received via interface 135 may be sent to and/or stored in a memory associated with server 106. The memory may be any suitable memory (e.g., hard drive, cloud-based storage, etc.) for storing data. Server 106 may be a financial institution backend or server that hosts (e.g., stores and executes instructions for) the one or more software modules.

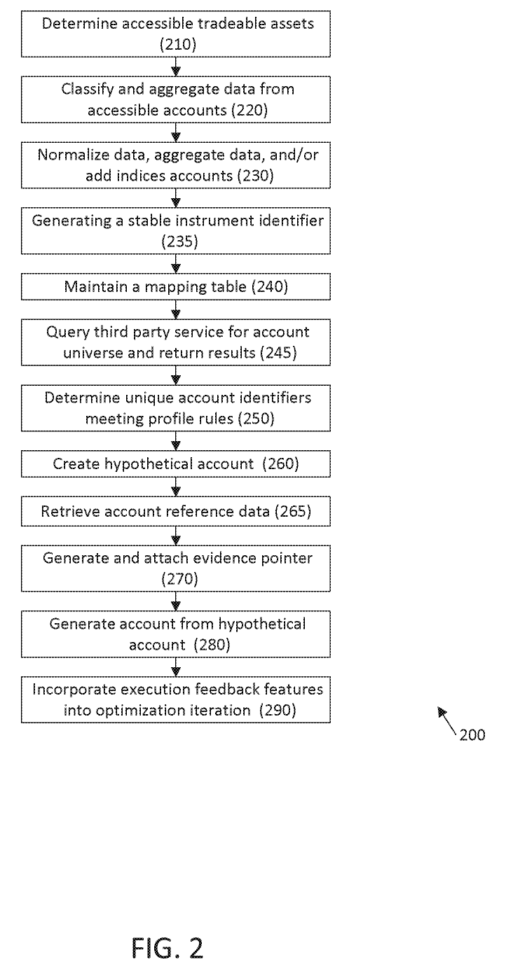

In some embodiments, instrument engine 108 may generate unique inventory identifiers consistent with disclosed embodiments. Instrument engine 108 may execute a method as described with reference to FIG. 2. Instrument engine 108 may pull information from one or more online data sources. Instrument engine 108 may generate a universe of possible and/or unknown inventories. In some embodiments, instrument engine 108 may include a LLM or be in operative communication with a LLM to normalize one or more records of unique inventory items and/or existing inventory items. Incoming data on inventory items may be inconsistent or lack quality. Instrument engine 108 may enrich data based on a determined missing field or entry or lack of quality. In some embodiments, the LLM may generate one or more fields for the inventory items based on determined enriched data to match other existing entries. In some embodiments, the LLM may de-duplicate inventory items using a threshold semantic similarity based on available data. In some embodiments, the LLM may match inventory items to a template format to enhance the quality of searches and selection.

In some embodiments, dashboard engine 110 may contain information regarding an account and/or account guidelines. Account guidelines may be saved by a user or may be generated by a financial institution.

In some embodiments, risk engine 112 may reference a credit res database and res notes database. Risk engine 112 may generate risk limits and/or internal guidelines. Risk engine 112 may be the custodian of an internal risk framework and/or account specific risk limits. The account specific risk limits may be granular and determine an account’s exposure limits on an issuer level. Risk engine 112 may be responsible to maintain an “approved issuer” list, where approved issuers are those that can be purchased from in connection with a specific account. Risk engine 112 may understand the guidelines of “digitized” accounts and marry them with the internal risk guidelines. This eventually enables portfolio optimizer 126 to be able to determine “room to grow” for accounts.

In some embodiments, exposure engine 114 may report one or more holdings of the account. Exposure engine 114 may be responsible for keeping an up-to-date view of an account’s exposure including intraday trades. Exposure engine 114 may be capable of slicing and dicing an accounts exposure in different views so as to be able to quickly determine an accounts exposure in a certain way. Finally, exposure engine 114 may calculate the “room to grow” for an account while considering the risk guidelines and the account’s current exposure.

In some embodiments, corporate inventory 116 may include one or more messages, chats, or recorded communications.

In some embodiments, money market inventory 118 may include information from one or more treasury curves including information from a third-party service and/or of a boom treasury curve.

In some embodiments, data curve 120 may include information from one or more treasury curves. In some embodiments, data curve 120 may create a data curve from one or more third party service information from one or more third party services 122.

In some embodiments, a market data engine 124 may include information from corporate inventory 116, money market inventory 118, and/or data curve 120. Market data engine 124 may include trade analytics from trade analyzer 134. Market data engine 124 may include an inventory reference from the information, pricing, and trade analytics.

In some embodiments, user portfolio optimizer 126 that receives information, pricing, and/or trade analytics from market data engine 124. Portfolio optimizer may receive information from one or more of instrument engine 108, dashboard engine 110, risk engine 112, and/or exposure engine 114. Portfolio optimizer 126 may generate suggested actions based on one or more of a duration, a risk, a sector, and/or a liquidity adjustment. Portfolio optimizer 126 may rank suggested actions. Portfolio optimizer 126 may generate a boom inventory and/or relative value versus a bills curve. Portfolio optimizer 126 may generate a bills versus notes relative value and/or an on or off of the run of a relative value.

Inputs of portfolio optimizer 126 may be one or more of risk analyzers, current holdings, qualitative input, and analytics (e.g., what is being offered at what level based on sector, historical, quality). In some embodiments, the risk analyzer may comprise a decision tree analysis as described further with reference to FIG. 2. In some embodiments, nodes (e.g., decision nodes) of a decision tree analysis may be binary or scaled. If binary, a decision node may be a yes or no or applied as a threshold (e.g., a threshold value). If scaled, a decision node may include a minimum value and a maximum value.

Portfolio optimizer 126 may apply one or more risk constraints or profile rules. Portfolio optimizer 126 may include a LLM or be in operative communication with the LLM to apply the one or more rules to select a set of assets. Portfolio optimizer 126 may suggest what instruments suit an account best based on inputs from the risk engine 112, exposure engine 114, instrument engine 108, dashboard engine 110, machine learning engine 128, and market data engine 124. Portfolio optimizer 126 may determine “relative cheapness” of instruments and optimizes relative cheapness based on inputs from the listed software modules.

Portfolio optimizer 126 may order one or more selected assets based on one or more of profile rules (e.g., account guidelines, risk rules) and rank/ordering of the selected assets.

In some embodiments, an order management system 130 may receive optimization information from portfolio optimizer 126. Order management system 130 may include a pre-trade compliance cleared order. Order management system 130 may enrich data with liquidity provider data.

In some embodiments, trade executor 132 may execute a trade. Trade executor 132 may include direct order routing, asset transferal, and/or portfolio trade execution.

In some embodiments, trade analyzer 134 may analyze one or more executed trades. Trade analyzer 134 may generate one or more spreads or trace data. Trade analyzer 134 may generate one or more feedback based on an executed trade.

In some embodiments, machine learning engine 128 may generate one or more portfolio insights including a variation versus a model and/or a suggested action. Machine learning engine 128 may be in operative communication with a chat bot in communication with one or more computers such as user electronic device 102 to answer questions and provide one or more portfolio insights regarding a financial account.

In some embodiments, server 106 implements an evidence-constrained insight generator configured to reduce unsupported machine-generated statements. The machine learning engine 128 generating evidence-constrained insights may include a retrieval subsystem configured to retrieve, from one or more internal databases and one or more third-party data sources, a set of authoritative data items corresponding to an account state, an instrument identifier, a pricing field, a guideline field, and/or a trade analytics field. The machine learning engine 128 may further include a generation subsystem configured to generate a candidate portfolio insight based on the authoritative data items, and/or a verification subsystem configured to compute, for the candidate portfolio insight, a support score representing a measured consistency between the candidate portfolio insight and the authoritative data items. When the support score fails to satisfy a threshold, the verification subsystem may suppress presentation of the candidate portfolio insight, replace the candidate portfolio insight with a request for additional data, or present a reduced-scope insight limited to fields that satisfy the threshold. In some embodiments, the verification subsystem may store an audit record that includes a hash of the authoritative data items used, a model identifier, a prompt identifier, and/or a timestamp, thereby enabling repeatable reconstruction of the generated output using the same authoritative inputs.

In some embodiments, machine learning engine 128 may perform claim-scoped attribution by attaching, to each sentence or clause of the candidate portfolio insight, an evidence pointer referencing at least one authoritative data item supporting that sentence or clause. The verification subsystem may reject any sentence and/or clause lacking an evidence pointer or having conflicting evidence pointers. In some embodiments, the evidence pointer references at least one of an instrument reference record, a guideline record, an executed-trade record, a trace-spread record, and/or a market-curve record. A display subsystem (e.g., dashboard engine 110, data analysis application 104) may render the evidence pointer as a selectable element to display the referenced record to the user.

In some embodiments, server 106 implements a guideline digitization compiler configured to transform one or more account guidelines and internal guidelines into an executable constraint representation. The guideline digitization compiler may ingest guideline source content that includes one or more of a natural-language document, a spreadsheet, a policy database record, and/or a message transcript, and may generate a machine-readable rule graph comprising nodes representing constraint predicates and edges representing dependency logic among constraints. In some embodiments, the compiler generates a static type for each guideline field, normalizes units, and/or inserts explicit exception handling for missing and/or unknown fields. In some embodiments, the rule graph is deployed to a runtime compliance engine configured to evaluate proposed trades against the rule graph using current exposure data and current market data, and to output a compliance decision and a minimal explanation path identifying which nodes of the rule graph determined the compliance decision.

In some embodiments, the runtime compliance engine provides a counterfactual compliance simulator configured to compute, for a proposed trade, one or more closest compliant alternatives by modifying at least one of a notional amount, a maturity bucket, a sector bucket, an issuer bucket, and/or an execution venue, subject to maintaining a target objective function. The counterfactual compliance simulator may output both a suggested compliant alternative and a list of constraint nodes that were binding constraints. In some embodiments, the portfolio optimizer consumes the binding constraints as inputs to a subsequent optimization iteration, thereby reducing repeated exploration of non-compliant actions.

In some embodiments, the instrument engine generates unique inventory identifiers using a deterministic canonicalization pipeline that reduces record fragmentation across heterogeneous sources. The canonicalization pipeline may include extracting structured fields from an incoming record, normalizing an issuer name using a learned alias table, normalizing a maturity representation, normalizing a coupon representation, and generating a canonical string. The instrument engine may compute a stable identifier by applying a cryptographic hash to the canonical string. In some embodiments, when one or more structured fields are missing, the instrument engine inserts explicit wildcard tokens into predetermined positions of the canonical string and generates a secondary identifier associated with a confidence score. In some embodiments, the instrument engine maintains a bidirectional mapping table between source-specific identifiers and the stable identifier, and updates the mapping table using incremental reconciliation when new third-party records are received.

In some embodiments, the instrument engine performs semantic de-duplication using a dual-stage matcher. A first stage may apply deterministic field matching on normalized fields. A second stage may compute an embedding similarity between two candidate instrument descriptions and apply a threshold. In some embodiments, when the deterministic stage and the embedding stage disagree, the instrument engine flags the record for human review and records the disagreement as training data for subsequent tuning of the matcher.

In some embodiments, the market data engine implements an event-driven streaming pipeline configured to update exposure, compliance, and/or optimization results in response to market events with reduced latency. The pipeline may ingest events comprising at least one of quote updates, curve updates, trade executions, guideline updates, and holdings updates. The pipeline may route events through an idempotent processing layer, comprising e.g., a program, an application, a network of computers executing a set of instructions, configured to deduplicate repeated events using an event identifier, and a state store (e.g., a state database) configured to maintain an account state snapshot. In response to an event, the exposure engine updates a computed exposure vector, the compliance engine updates compliance status, and/or the portfolio optimizer recomputes a ranked action list, wherein each recomputation is restricted to the impacted instruments and impacted constraints as determined by a dependency index.

In some embodiments, the machine learning engine implements a safety policy layer, comprising e.g., a program, an application, a network of computers executing a set of instructions, configured to constrain output of a large language model. The safety policy layer may enforce one or more rules including prohibiting the model from generating numerical values absent an authoritative data item containing that numerical value, prohibiting the model from asserting compliance absent an affirmative compliance decision from the runtime compliance engine, and/or requiring the model to render uncertainty as an explicit probability interval when authoritative data items are incomplete. In some embodiments, the safety policy layer is executed as a pre-output filter configured to rewrite or block outputs that violate a rule, and the system logs a rule violation event for monitoring and model governance.

In some embodiments, the trade analyzer generates execution feedback features for closed-loop optimization. The trade analyzer may compute realized spread, slippage, fill rate, and/or post-trade markout as a function of time. The portfolio optimizer may incorporate the feedback features to update a venue-selection model and a liquidity-adjustment model, thereby adapting subsequent order routing for similar instruments under similar market conditions. In some embodiments, the feedback features may be written to a feature store indexed by stable instrument identifier and market regime identifier, and the portfolio optimizer may read the feature store during optimization to apply regime-specific liquidity penalties.

In some embodiments, the system includes a deterministic explanation generator configured to output, for each suggested action, an explanation object comprising a set of input records, a compliance path, an objective contribution breakdown, and/or a risk contribution breakdown. The explanation object may be generated without reliance on a generative model and may be rendered in the portfolio dashboard as a drill-down view. In some embodiments, the explanation object is cryptographically signed and stored with an order record to provide an auditable basis for the suggested action at the time of suggestion.

In some embodiments, the system provides a sandbox execution mode in which the order management system generates a simulated order, runs the simulated order through pre-trade compliance, routes the simulated order through a simulated execution venue model, and returns an expected execution quality metric. In some embodiments, the system displays both a real order option and a simulated order option, and restricts automatic execution to scenarios satisfying both compliance and a minimum expected execution quality threshold.

In some embodiments, the system includes an evidence-constrained insight generator configured to generate portfolio insights while reducing unsupported machine-generated content. The evidence-constrained insight generator may retrieve authoritative data items from one or more internal databases and one or more third-party data sources, the authoritative data items including account state fields, instrument identifier fields, guideline fields, pricing fields, and/or trade analytics fields. A large language model may generate a candidate portfolio insight based on the authoritative data items. A verification subsystem may compute a support score representing measured consistency between the candidate portfolio insight and the authoritative data items, and may suppress, rewrite, or narrow the candidate portfolio insight when the support score fails to satisfy a threshold. In some embodiments, the verification subsystem attaches an evidence pointer to each sentence or clause of an output portfolio insight, each evidence pointer referencing at least one authoritative data item, and prevents display of any sentence or clause lacking an evidence pointer.

In some embodiments, the system enforces a safety policy layer that constrains outputs of the large language model. The safety policy layer may prohibit generation of numerical values absent an authoritative data item containing the numerical values, may prohibit assertions of compliance absent an affirmative compliance decision from a runtime compliance engine, and may require explicit uncertainty formatting when authoritative data items are incomplete.

In some embodiments, account guidelines and internal guidelines may be compiled into an executable constraint representation. User portfolio optimizer 126 may include a guideline digitization compiler (not shown) that may ingest guideline source content comprising one or more of a natural-language document, a spreadsheet, a policy database record, and/or a message transcript, and may generate a machine-readable rule graph comprising nodes representing constraint predicates and edges representing dependency logic among constraints. User portfolio optimizer 126 may evaluate a proposed trade against the rule graph using current exposure data and current market data to generate pre-trade compliance and to output an explanation path identifying which nodes determined a compliance decision.

In some embodiments, user portfolio optimizer 126 may include a counterfactual compliance simulator configured to compute a closest compliant alternative to a proposed trade by modifying at least one of a notional amount, a maturity bucket, an issuer bucket, a sector bucket, and/or an execution venue while maintaining a target objective. The closest compliant alternative may be provided for display in a display (e.g., dashboard engine 110, data analysis application 104) together with a list of binding constraints.

In some embodiments, instrument engine 108 may generate stable instrument identifiers using a deterministic canonicalization pipeline (e.g., a method executed as a list of instructed stored on a memory). The canonicalization pipeline may extract structured fields from incoming instrument records, normalize issuer naming using an alias table, normalize maturity representations, normalize coupon representations, and/or generate a canonical string. Instrument engine 108 may generate a stable identifier by applying a cryptographic hash to the canonical string and may maintain a bidirectional mapping table between source-specific identifiers and the stable identifier. When one or more structured fields are missing, instrument engine 108 may insert wildcard tokens into predetermined positions of the canonical string so that the instrument may be processed despite missing, garbled, and/or unexpected field entries. In some embodiments, instrument engine 108 may generate a secondary identifier associated with a confidence score so that the confidence score may be tracked and associated with the instrument.

In some embodiments, user portfolio optimizer 126, in communication with order management system 130 and/or trade executor 132, may include an event-driven streaming pipeline (e.g., a method executed as a list of instructed stored on a memory) configured to update exposure, compliance, and/or optimization results in response to market events. The event-driven streaming pipeline may include ingesting events comprising quote updates, curve updates, guideline updates, holdings updates, and/or executed trade events. The pipeline may deduplicate repeated events using an event identifier and maintain an account state snapshot in a state store. In response to an event, the portfolio optimizer may recompute a ranked action list, wherein the recomputation is restricted to impacted instruments and impacted constraints determined using a dependency index.

In some embodiments, trade analyzer 134 computes execution feedback features comprising realized spread, slippage, fill rate, and/or post-trade markout. Trade analyzer 134 may include storing the execution feedback features in a feature store indexed by stable instrument identifier and market regime identifier. User portfolio optimizer 126, in communication with market data engine 124, may incorporate the execution feedback features into subsequent optimization iterations to adjust liquidity penalties and venue selection for later orders.

In some embodiments, data analysis application 104 may include an explanation generator configured to generate an explanation object for each suggested action. The explanation object may identify input records used, a compliance path, and/or an objective contribution breakdown. The explanation object may be stored with an order record to provide an auditable basis for the suggested action at a time of suggestion.

In some embodiments, order management system 130 may provide a sandbox execution mode comprising generating a simulated order, evaluating the simulated order for pre-trade compliance, routing the simulated order through a simulated execution venue model, and/or determining an expected execution quality metric. Automatic execution may be restricted to scenarios in which both pre-trade compliance is satisfied and the expected execution quality metric satisfies a threshold.

FIG. 2 illustrates method 200 for identity proofing, in accordance with some embodiments. Method 200 may be stored as a list of instructions stored on a memory that when executed by one or more processors cause the one or more processors to perform the method.

At 210, a server (e.g., server 106) may determine accessible tradeable assets such as a bond, a part, a consumer item, an assembly, and/or other inventory item from one or more external computerized digital databases. The determination may be based on one or more electronic documents of the computerized digital databases that the server links to the record of the one or more accessible tradeable assets. The determination may be based on a listing by a particular entity (e.g., a listing entity that manages the computerized digital databases by pulling information from a distributed ledger, a cloud-based database, a bid-ask database).

At 220, the server may include classifying and/or aggregating data of electronic records of the accessible tradeable assets. The accessible tradeable assets may be possible investable instruments. The server may include or be in operative communication with a large language model (“LLM”) configured to classify the accessible tradeable assets. The LLM may be optimized based on training data of previously known accessible tradeable assets. The LLM may classify the records based on one or more of a date, a type of asset (e.g., bond, stock, physical item, ledger entry on a distributed ledger, etc.), an expiration date, description, offer expiration, a related industry, an offering party, expected return on investment, and value.

In some embodiments, dynamically aggregating and/or enriching data for each accessible tradeable asset. Dynamic aggregation may include pulling data for each of the one or more records. Enriching data and/or dynamic aggregation may include entering or creating one or more fields based on available data from a source document or a third-party document (e.g., price data, reference data from an issuer, real-time quotes). In some embodiments, dynamic aggregation may occur through on or more application programming interface (“API”) calls to a financial institution for information about one or more assets.

At 230, the server may normalize the one or more records based on one or more standardization templates to the records, for example, to place each accessible tradeable asset record in a string of characters that uniquely identify the accessible tradeable asset (e.g., offering party.description, value.offer expiration). The server may include or be in operative communication with a large language model (“LLM”) configured to normalize the accessible tradeable assets. The LLM may be optimized based on training data of previously known record strings based on the classification. In some embodiments, the normalization may include inserting a unique identifier and/or any combination or number of classifications. In some embodiments, wildcard values may be inserted for gap or unknown characters so the strings are of a target length.

At 235, the instrument engine may generate a stable instrument identifier, consistent with disclosed embodiments, by applying a deterministic canonicalization pipeline to the structured fields to generate a canonical string and applying a cryptographic hash to the canonical string.

At 240, the instrument engine may maintain a mapping table that associates a source-specific identifier of an incoming instrument record with the stable instrument identifier, and/or, when one or more structured fields are missing, generating a secondary identifier by inserting wildcard tokens into predetermined positions of the canonical string and associating the secondary identifier with a confidence score.

At 245, the server may query one or more third party services for unknown accessible tradeable assets. In some embodiments, the server may pull all available data on one or more accounts that has been updated in a time period. In this way, the server may pull data that has been updated since the last iteration. The server may pull the data from one or more documents, data lake, and/or a database accessible over a network. The one or more accounts may be digitized accounts. A “digitized” account’s risk guidelines are machine readable and that enables the account to participate in “room to grow” calculations (e.g., how much of an instrument an account can buy and remain compliant with financial institution risk guidelines and/or account specific guidelines) A digitized account may enable one or more machine learning models executed by the server or in communication with the server to learn from past trades, current market conditions, available inventory, and/or investment themes to be able to suggest trades.

At 250, the server may determine one or more unique accessible tradeable asset identifiers based on the potential accessible tradeable assets and unknown accessible tradeable assets. The one or more unique accessible tradeable asset identifiers may be associated with a newly available asset. The newly available asset may be checked by a check LLM against existing records to determine whether the newly available asset is unique. If a confidence score is of a sufficient threshold, the newly available asset may be classified and normalized as discussed above. In some embodiments, the newly available asset may be determined to be unique based on two or more or three or more classifications that differ from the one or more records.

At 260, the server may create a hypothetical account. The hypothetical account may assume that an amount has been dispersed among a selected set of assets. In some embodiments, the server may apply one or more profile rules to determine the selected set of assets from the one or more records and/or the newly available assets. In some embodiments, the profile rules may be applied through the server’s LLM or the server’s operative communication with a LLM. In some embodiments, a profile rule LLM may be trained based on application of the one or more profile rules to optimize selection of assets based on the profile rules. The profile rules may include one or more of a type of desired asset, a desired return on investment, an acceptable offer or asset expiration date, a location of physical space associated with the hypothetical account, a location of a database or institution associated with the hypothetical account, a desired related industry, a desired analyst rating, an expert/advisor rating, a value, a volume associated with the asset, a risk limit (e.g., as a function of expected value, time, appreciation), and a comparison of the desired asset versus a treasury yield, bond, or baseline commodity/asset. In some embodiments, the LLM may apply the profile rules as one or more nodes of a decision tree. In some embodiments, the one or more nodes may be binary (e.g., acceptable above or below a threshold) or scaled (e.g., weighted based on how the profile rule scales between a set minimum and/or maximum). In some embodiments, the selected set of assets may be weighted (e.g., 10% of the account for one asset, 5% for another asset, less than 5% for remaining assets) according to desirability (e.g., expected value or a ranking of one or more profile rules). In some embodiments, a number of the selected set of assets may be capped at a threshold number (e.g., ten, twenty, one hundred). The hypothetical account may be accessible by one or more connected computer networks.

At 265 the server may retrieve reference data for the selected set of assets. The reference data may include one or more events. Events may be generated by one or more of an expert, from an internet search, from a third party reporting service, and from a source of the selected asset of the selected set of assets. One or more events may include a number of hits from a previous period of time among one or more news sources (e.g., hits within the last hour/day). In some embodiments, the server may, through an LLM or in operative communication with a LLM, determine whether one or more news sources include hits related to the one or more records by, for example, semantic similarity.

At 270, the server may attach, by a verification subsystem, an evidence pointer to each sentence or clause of the output portfolio insight, each evidence pointer referencing at least one authoritative data item. The server may prevent display of any sentence or clause lacking an evidence pointer.

At 280, the server may generate an account based on the hypothetical account and the reference data. The server may execute one or more trades for one or more assets including recording movement of one or more resources into and out of the account. The server may generate a record for a distributed ledger based on the transfer of resources. The server may order a transfer of a physical item. The server may execute a bond or stock transfer. The account may be generated more quickly and efficiently than conventional means. The account may be generated with a higher likelihood of achieving account guidelines and/or goals, taking into account information relevant to each considered asset and events.

At 290, the server may incorporate, by a portfolio optimizer, the one or more execution feedback features from the feature store into a subsequent optimization iteration to adjust at least one of a liquidity penalty or a venue selection parameter for a subsequent suggested action.

Method 200 may reduce latency and improve consistency of account state processing by ingesting streaming market and account events, deduplicating repeated events using event identifiers, and maintaining an account state snapshot in a state store. Method 200 may improve data integrity across heterogeneous inventory sources by deterministically canonicalizing instrument records, generating stable instrument identifiers (including mapping tables, wildcard-based secondary identifiers, and confidence scoring), and thereby reducing duplicate records and improving joins across databases. Method 200 may reduce compute load under high-frequency updates by restricting recomputation of ranked actions to impacted instruments and constraints using a dependency index.

Method 200 may increase reliability and determinism of pre-trade compliance evaluation by compiling guidelines into a machine-readable rule graph and executing the rule graph at runtime using current exposure and market data. Method 200 may improve transparency and debuggability by outputting an explanation path that identifies determinative rule nodes, which may enable validation, testing, and governance of compliance decisions. Method 200 may further compute closest compliant alternatives by adjusting trade parameters while maintaining objectives, which may reduce repeated non-compliant iterations and improve system throughput.

Method 200 may reduce unsupported or inconsistent machine-generated outputs by retrieving authoritative data items, generating candidate insights, computing support scores, and suppressing, rewriting, or narrowing outputs that fail thresholds. Method 200 may enforce output safety constraints that prohibit numerical assertions without authoritative fields and prohibit compliance assertions without an affirmative compliance decision, and may attach evidence pointers at a sentence or clause level to improve traceability of displayed content. Method 200 may improve auditability and continuous optimization by storing hashed audit records with model identifiers and timestamps, computing post-trade execution feedback features (including slippage and markout), persisting the features in a feature store, and incorporating the features into subsequent optimization iterations to adapt liquidity penalties and venue selection.

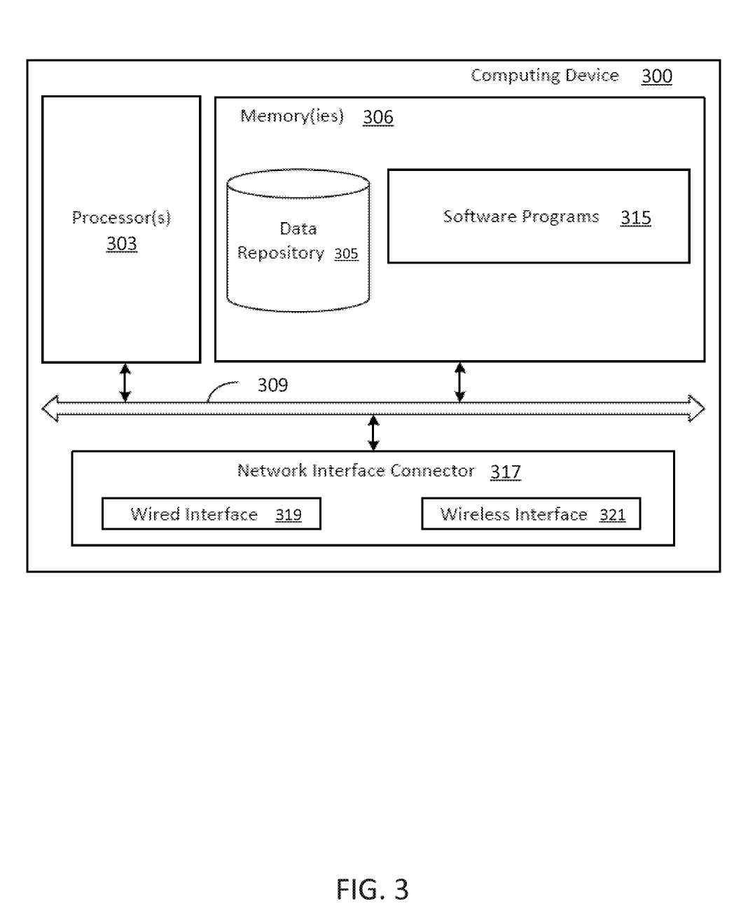

FIG. 3 is a block diagram of a computing device for implementing certain Embodiments of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various Embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some Embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many Embodiments and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary Embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such Embodiments, adaptations, variations, modifications, or equivalent arrangements.

1. A method comprising:
determining ,by an instrument engine executed by a server comprising one or more processors, potential accessible tradeable assets and unknown accessible tradeable assets associated with a financial account;
determining, by a dashboard engine executed by the server, a state of a financial account and related guidelines;
determining, by a risk engine executed by the server, one or more risk limits and one or more internal guidelines of a trade associated with the potential accessible tradeable assets or unknown accessible tradeable assets;
displaying, by an exposure engine executed by the server, one or more holdings or analyst views;
displaying, by a portfolio dashboard executed by the server, an account view, a cash-to-spend view, and an account exposure limit and a current limit;
determining, by a large language model comprising a machine learning model executed by the server, a portfolio insight, a variation versus a model and a suggested action;
optimizing, by a portfolio optimizer executed by the server, the financial account based on a duration, a risk, a sector, and an adjusted liquidity;
determining, by an order management system executed by the server, pre-trade compliance and enriching data with liquidity provider data, the order management system configured to send an order to the user for execution, the order comprising a direct order routing and a portfolio trade execution; and
determining, by a trade analyzer by the server, the trade analytics being used by the portfolio optimizer to incorporate feedback of the trade into the optimizer for the suggested action.

2. The method of claim 1, further comprising retrieving, by a retrieval subsystem executed by the server, authoritative data items from at least one internal database and at least one third-party data source, the authoritative data items including at least an account state field, an instrument identifier field, and a guideline field.

3. The method of claim 2, wherein determining the portfolio insight comprises generating, by the large language model, a candidate portfolio insight based on the authoritative data items, computing, by a verification subsystem executed by the server, a support score representing measured consistency between the candidate portfolio insight and the authoritative data items, and suppressing or rewriting at least a portion of the candidate portfolio insight in response to the support score failing to satisfy a threshold.

4. The method of claim 3, further comprising attaching, by the verification subsystem, an evidence pointer to each sentence or clause of an output portfolio insight, each evidence pointer referencing at least one of the authoritative data items, and preventing display of any sentence or clause lacking an evidence pointer.

5. The method of claim 3, wherein suppressing or rewriting comprises prohibiting generation of a numerical value absent an authoritative data item containing the numerical value, and prohibiting an assertion of compliance absent an affirmative compliance decision generated by a runtime compliance engine.

6. The method of claim 3, further comprising storing, by the server, an audit record comprising a hash of at least a portion of the authoritative data items used to generate the output portfolio insight, a model identifier, a prompt identifier, and a timestamp.

7. The method of claim 1, further comprising compiling, by a guideline digitization compiler executed by the server, a guideline source document into a machine-readable rule graph comprising nodes representing constraint predicates and edges representing dependency logic among constraints, and evaluating, by a runtime compliance engine executed by the server, a proposed trade against the rule graph using current exposure data to generate the pre-trade compliance.

8. The method of claim 7, wherein evaluating the proposed trade further comprises outputting, by the runtime compliance engine, an explanation path identifying a subset of the nodes that determined a compliance decision.

9. The method of claim 7, further comprising computing, by a counterfactual compliance simulator executed by the server, a closest compliant alternative to the proposed trade by modifying at least one of a notional amount, a maturity bucket, an issuer bucket, or an execution venue while maintaining a target objective, and providing the closest compliant alternative for display in the portfolio dashboard.

10. The method of claim 1, further comprising generating, by the instrument engine, a stable instrument identifier by applying a deterministic canonicalization pipeline to an incoming instrument record to generate a canonical string, and applying a cryptographic hash to the canonical string to obtain the stable instrument identifier.

11. The method of claim 10, wherein the deterministic canonicalization pipeline comprises normalizing an issuer name using an alias table, normalizing a maturity representation, and normalizing a coupon representation, and wherein the instrument engine maintains a bidirectional mapping table between a source-specific identifier and the stable instrument identifier.

12. The method of claim 10, further comprising generating, by the instrument engine, a secondary identifier by inserting wildcard tokens into predetermined positions of the canonical string when a structured field is missing, and associating the secondary identifier with a confidence score.

13. The method of claim 1, further comprising ingesting, by an event-driven pipeline executed by the server, streaming events comprising at least one of quote updates, curve updates, guideline updates, holdings updates, and executed trade events, deduplicating repeated events using an event identifier, and updating an account state snapshot stored in a state store.

14. The method of claim 13, further comprising recomputing, by the portfolio optimizer, a ranked action list in response to a streaming event, wherein the recomputing is restricted to impacted instruments and impacted constraints determined using a dependency index.

15. The method of claim 1, wherein determining the trade analytics comprises computing, by the trade analyzer, at least one execution feedback feature selected from realized spread, slippage, fill rate, and post-trade markout, storing the at least one execution feedback feature in a feature store indexed by stable instrument identifier, and incorporating, by the portfolio optimizer, the at least one execution feedback feature into a subsequent optimization iteration.

16. The method of claim 1, further comprising generating, by an explanation generator executed by the server and independent of the large language model, an explanation object for the suggested action, the explanation object comprising an identified set of input records, a compliance path, and an objective contribution breakdown, and storing the explanation object with an order record.

17. A computer-implemented method comprising:
ingesting, by an event-driven pipeline executed by one or more processors of a server, streaming events comprising at least one of quote updates, curve updates, holdings updates, guideline updates, and executed trade events;
deduplicating, by the event-driven pipeline, repeated ones of the streaming events using an event identifier, and updating an account state snapshot stored in a state store;
retrieving, by a retrieval subsystem executed by the server, authoritative data items from at least one internal database and at least one third-party data source based on the account state snapshot, the authoritative data items comprising at least an instrument identifier field, a guideline field, and a pricing or analytics field;
generating, by a large language model executed by the server, a candidate portfolio insight based on the authoritative data items;
computing, by a verification subsystem executed by the server, a support score representing measured consistency between the candidate portfolio insight and the authoritative data items;
in response to the support score failing to satisfy a threshold, suppressing, rewriting, or narrowing the candidate portfolio insight to generate an output portfolio insight;
attaching, by the verification subsystem, an evidence pointer to each sentence or clause of the output portfolio insight, each evidence pointer referencing at least one of the authoritative data items;
evaluating, by a runtime compliance engine executed by the server, a proposed trade associated with the output portfolio insight to generate a pre-trade compliance decision; and
providing, by the server to a user interface, the output portfolio insight together with an indication of the pre-trade compliance decision.

18. The method of claim 17, further comprising: compiling, by a guideline digitization compiler executed by the server, a guideline source document into a machine-readable rule graph comprising nodes representing constraint predicates and edges representing dependency logic among constraints; and outputting, by the runtime compliance engine, an explanation path identifying a subset of the nodes that determined the pre-trade compliance decision.

19. A system comprising:
one or more processors; and
a memory storing instructions that, when executed by the one or more processors, cause the system to:
maintain, via an event-driven pipeline, an account state snapshot by ingesting streaming events, deduplicating repeated ones of the streaming events using an event identifier, and writing the account state snapshot to a state store;
retrieve, via a retrieval subsystem, authoritative data items from at least one internal database and at least one third-party data source based on the account state snapshot;
generate, via a large language model, a candidate portfolio insight based on the authoritative data items; compute, via a verification subsystem, a support score representing measured consistency between the candidate portfolio insight and the authoritative data items and, based on the support score, suppress, rewrite, or narrow the candidate portfolio insight to generate an output portfolio insight;
enforce, via a safety policy layer, at least one output constraint including (i) prohibiting generation of a numerical value absent an authoritative data item containing the numerical value and (ii) prohibiting an assertion of compliance absent an affirmative compliance decision from a runtime compliance engine;
evaluate, via the runtime compliance engine, a proposed trade to generate a pre-trade compliance decision; and
display, on a portfolio dashboard, of the output portfolio insight and the pre-trade compliance decision.

20. The system of claim 19, wherein the instructions further cause the system to: generate, via an instrument engine, a stable instrument identifier by applying a deterministic canonicalization pipeline to an incoming instrument record to generate a canonical string and applying a cryptographic hash to the canonical string; and store, via the verification subsystem, an audit record comprising at least a hash of at least a portion of the authoritative data items used to generate the output portfolio insight, a model identifier, and a timestamp.
